(19) United States
(12) Patent Application Publication
(10) Pub. No.: US 2009/0189896 A1
(43) Pub. Date: Jul. 30, 2009

(54) Graphics Processor having Unified Shader Unit

(75) Inventors: Jeff Jiao, San Jose, CA (US); Timour Paltashev, Laveen, AZ (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA Technologies, Inc., Taipei (TW)

(21) Appl. No.: 12/019,741

(22) Filed: Jan. 25, 2008

(51) Int. Cl. G06T 15/50

(52) U.S. Cl. 345/426

(57) ABSTRACT

Graphics processing units (GPUs) are used, for example, to process data related to three-dimensional objects or scenes and to render the three-dimensional data onto a two-dimensional display screen. One embodiment, among others, of a GPU is disclosed herein, wherein the GPU includes a control device configured to receive vertex, geometry and pixel data. The GPU further includes a plurality of execution units connected in parallel, each execution unit configured to perform a plurality of graphics shading functions on the vertex, geometry and pixel data. The control device is further configured to allocate a portion of the vertex, geometry and pixel data to each execution unit in a manner to substantially balance the load among the execution units.

### CROSS-REFERENCE TO RELATED APPLICATIONS

This application is related to copending U.S. patent application Ser. No. ______ (Docket No. S3U06-0031; 252209-1820), filed on the same day as the present application, and entitled “Graphics Processor Having Unified Cache System,” which is incorporated by reference in its entirety into the present disclosure.

### TECHNICAL FIELD

The present disclosure generally relates to three-dimensional computer graphics systems. More particularly, the disclosure relates to graphics processing systems having a combination of shading functionality.

### BACKGROUND

Three-dimensional (3D) computer graphics systems, which can render objects from a 3D world (real or imaginary) onto a two-dimensional (2D) display screen, are currently used in a wide variety of applications. For example, 3D computer graphics can be used for real-time interactive applications, such as computer games, virtual reality, scientific research, etc., as well as off-line applications, such as the creation of high resolution movies, graphic art, etc. Because of a growing interest in 3D computer graphics, this field of technology has been developed and improved significantly over the past several years.

In order to render 3D objects onto a 2D display, objects to be displayed are defined in a 3D “world space” using space coordinates and color characteristics. The coordinates of points on the surface of an object are determined and the points, or vertices, are used to create a wireframe connecting the points to define the general shape of the object. In some cases, these objects may have “bones” and “joints” that can pivot, rotate, etc., or may have characteristics allowing the objects to bend, compress, deform, etc. A graphics processing system can gather the vertices of the wireframe of the object to create triangles or polygons. For instance, an object having a simple structure, such as a wall or a side of a building, may be defined by four planar vertices forming a rectangular polygon or two triangles. A more complex object, such as a tree or sphere, may be defined by hundreds of vertices forming hundreds of triangles.

In addition to defining vertices of an object, the graphics processor may also perform other tasks such as determining how the 3D objects will appear on a 2D screen. This process includes determining, from a single “camera view” pointed in a particular direction, a window frame view of this 3D world. From this view, the graphics processor can clip portions of an object that may be outside the frame, hidden by other objects, or facing away from the “camera” and hidden by other portions of the object. Also, the graphics processor can determine the color of the vertices of the triangles or polygons and make certain adjustments based on lighting effects, reflectivity characteristics, transparency characteristics, etc. Using texture mapping, textures or colors of a flat picture can be applied onto the surface of the 3D objects as if putting skin on the object. In some cases, the color values of the pixels located between two vertices, or on the face of a polygon formed by three or more vertices, can be interpolated if the color values of the vertices are known. Other graphics processing techniques can be used to render these objects onto a flat screen.

As is known, the graphics processors include components referred to as “shaders”. Software developers or artists can utilize these shaders to create images and control frame-by-frame video as desired. For example, vertex shaders, geometry shaders, and pixel shaders are commonly included in graphics processors to perform many of the tasks mentioned above. Also, some tasks are performed by fixed function units, such as rasterizers, pixel interpolators, triangle setup units, etc. By creating a graphics processor having these individual components, a manufacturer can provide a basic tool for creating realistic 3D images or video. However, different software developers or artists may have different needs, depending on their particular application. Because of this, it can difficult to determine up front what proportion of each of the shader units or fixed function units of the total processing core should be included in the graphics processor. Thus, a need exists in the art of graphics processors to address the accumulation and proportioning of separate types of shaders and fixed function units based on application. It would therefore be desirable to provide a graphics processing system capable of overcoming these and other inadequacies and deficiencies in the 3D graphics technology.

### SUMMARY

Graphics processing units (GPUs) are described in the present disclosure. In some embodiments, the GPUs are configured with programmable shading units embodied in a unified shader or in parallel execution units, allowing greater flexibility and scalability than conventional systems. In one presently described embodiment, among others, a GPU comprises a control device configured to receive vertex data and a plurality of execution units connected in parallel. Each execution unit is configured to perform a plurality of graphics shading functions on the vertex data. The control device is further configured to allocate a portion of the vertex data to each execution unit. The control device allocates the vertex data in a manner to substantially balance the load among the execution units. A similar control device may allocate pixel data among the execution units as well.

The present disclosure also describes the individual execution units. In one embodiment, among others, an execution unit comprises a data path having logic for performing vertex shading functionality, logic for performing geometry shading functionality, logic for performing rasterization functionality, and logic for performing pixel shading functionality. The execution unit also comprises a cache system and a thread control device configured to control the data path based on an allocation assignment. The data path is further configured to perform one or more of the vertex shading functionality, geometry shading functionality, rasterization functionality, or pixel shading functionality based on the allocation assignment.

Other systems, methods, features, and advantages of the present disclosure will be apparent to one having skill in the art upon examination of the following drawings and detailed description. It is intended that all such additional systems, methods, features, and advantages be included within this description and protected by the accompanying claims.

### BRIEF DESCRIPTION OF THE DRAWINGS

Many aspects of the embodiments disclosed herein can be better understood with reference to the following drawings. Like reference numerals designate corresponding parts throughout the several views.

FIG. 1 is a block diagram of a graphics processing system according to one embodiment of the present disclosure.

FIG. 2 is a block diagram of an embodiment of the graphics processing unit shown in FIG. 1.

FIG. 3A is a block diagram of another embodiment of the graphics processing unit shown in FIG. 1.

FIG. 3B is a block diagram of another embodiment of the graphics processing unit shown in FIG. 1.

FIG. 3C is a block diagram of yet another embodiment of the graphics processing unit shown in FIG. 1.

FIG. 4 is a block diagram of an embodiment of an execution unit according to the execution units shown in FIGS. 3A-3C.

FIG. 5 is a block diagram of another embodiment of an execution unit according to the execution units shown in FIGS. 3A-3C.

FIG. 6 is a block diagram of yet another embodiment of an execution unit according to the execution units shown in FIGS. 3A-3C.

FIG. 7 is a block diagram of an embodiment of a common register file interface in accordance with FIG. 5 or 6.

FIG. 8 is a flow diagram illustrating the flow of signals with respect to the common register file shown in FIG. 5 or 6.

### DETAILED DESCRIPTION

Conventionally, graphics processors or graphics processing units (GPUs) are incorporated into a computer system for specifically performing computer graphics. With the greater use of three-dimensional (3D) computer graphics, GPUs have become more advanced and more powerful. Some tasks normally handled by a central processing unit (CPU) are now handled by GPUs to accomplish graphics processing having great complexity. Typically, GPUs may be embodied on a graphics card attached to or in communication with a motherboard of a computer processing system.

GPUs contain a number of separate units for performing different tasks to ultimately render a 3D scene onto a two-dimensional (2D) display screen, such as a television, computer monitor, video screen, or other suitable display device. These separate processing units are usually referred to as “shaders” and may include, for example, vertex shaders, geometry shaders, and pixel shaders. Also, other processing units referred to as fixed function units, such as pixel interpolators and rasterizers, are also included in the GPUs. When designing a GPU, the combination of each of these components is taken into consideration to allow various tasks to be performed. Based on the combination, the GPU may have a greater ability to perform one task while lacking full ability for another task. Because of this, hardware developers have attempted to place some shader units together into one component. However, the extent to which separate units have been combined has been limited.

The present disclosure discusses the combining of the shader units and fixed function units into a single unit, referred to herein as a unified shader. The unified shader has the ability to perform the functions of vertex shading, geometry shading, and pixel shader, as well as perform the functions of rasterization, pixel interpolation, etc. Also, by including a device for determining allocation, the rendering of 3D can be dynamically adjusted based on the particular need at the time. By observing the current and past needs of individual functions, the allocation mechanism can adjust the allocation of the processing facilities appropriately to efficiently and quickly process the graphics data.

As an example, when the unified shader determines that many objects defined within the 3D world space have a simple structure, such as a scene inside a room having many planar walls, floors, ceilings, and doors, a vertex shader in this case is not utilized to its fullest extent. Therefore, more processing power can be allocated to the pixel shader, which may need to process complex textures. On the other hand, if a scene includes many complex shapes, such as a scene within a forest, more processing power may be needed by the vertex shader and less for the pixel shader. Even if a scene changes, such as moving from an outside scene to an indoor scene or vice versa, the unified shader can dynamically adjust the allocation of the shaders to meet the particular demand.

Furthermore, the unified shader may be configured having several parallel units, referred to herein as execution units, where each execution unit is capable of the full range of graphics processing shading tasks and fixed function tasks. In this way, the allocation mechanism may dynamically configure each execution unit or portions thereof to process a particular graphics function. The unified shader, having a number of similarly functioning execution units, can be flexible enough to allow a software developer to allocate as needed, depending on the particular scene or object. In this way, the GPU can operate more efficiently by allocating the processing resources as needed. This on-demand resource allocation scheme can provide faster processing speeds and allow for more complex rendering.

Another advantage of the unified shader described herein is that the capability or size of each execution unit can be relatively simple. By combining the execution units in parallel, the performance of the GPU can be changed simply by adding or subtracting execution units. Since the number of execution units can be changed, a GPU having a lower level of execution capacity can be developed for simple inexpensive graphics processing. Also, the number of execution units can be increased or scaled up to cater to higher level users. Because of the versatility of the execution units to perform a great number of graphics processing functions, the performance of the GPU can be determined simply by the number of execution units included. The scaling up or scaling down of the execution units can be relatively simple and does not require complex re-engineering designs to satisfy a range of low level or high level users.

The GPUs, unified shaders, and execution units described herein are designed to meet DirectX and OpenGL specifications. A more detailed description of the embodiments of these components will now be discussed in the following.

FIG. 1 is a block diagram of an embodiment of a computer graphics system 10. The computer graphics system 10 includes a computing system 12, a graphics module 14, and a display device 16. The computing system 12 includes, among other things, a graphics processing unit (GPU) 18 for processing at least a portion of the graphical data handled by the computing system 12. In some embodiments, the GPU 18 may be configured on a graphics card within the computing system 12. The GPU 18 processes the graphics data to generate color values and luminance values for each pixel of a frame for display on the display device 16, normally at a rate of 30 frames per second. The graphics software module 14 includes an application programming interface (API) 20 and a software program application 22. The API 20, in this embodiment, adheres to the latest OpenGL and/or DirectX specifications.

In recent years, a need has arisen to utilize a GPU having more programmable logic. In this embodiment, the GPU 18 is configured with greater programmability. A user can control a number of input/output devices to interactively enter data and/or commands via the graphics module 14. The API 20, based on logic in the application 22, controls the hardware of the GPU 18 to create the available graphics functions of the GPU 18. In the present disclosure, the user may be unaware of the GPU 18 and its functionality, particularly if the graphics module 14 is a video game console and the user is simply someone playing the video game. If the graphics module 14 is a device for creating 3D graphic videos, computer games, or other real-time or off-line rendering and the user is a software developer or artist, this user may typically be more aware of the functionality of the GPU 18. It should be understood that the GPU 18 may be utilized in many different applications. However, in order to simplify the explanations herein, the present disclosure focuses particularly on real-time rendering of images onto the 2D display device 16.

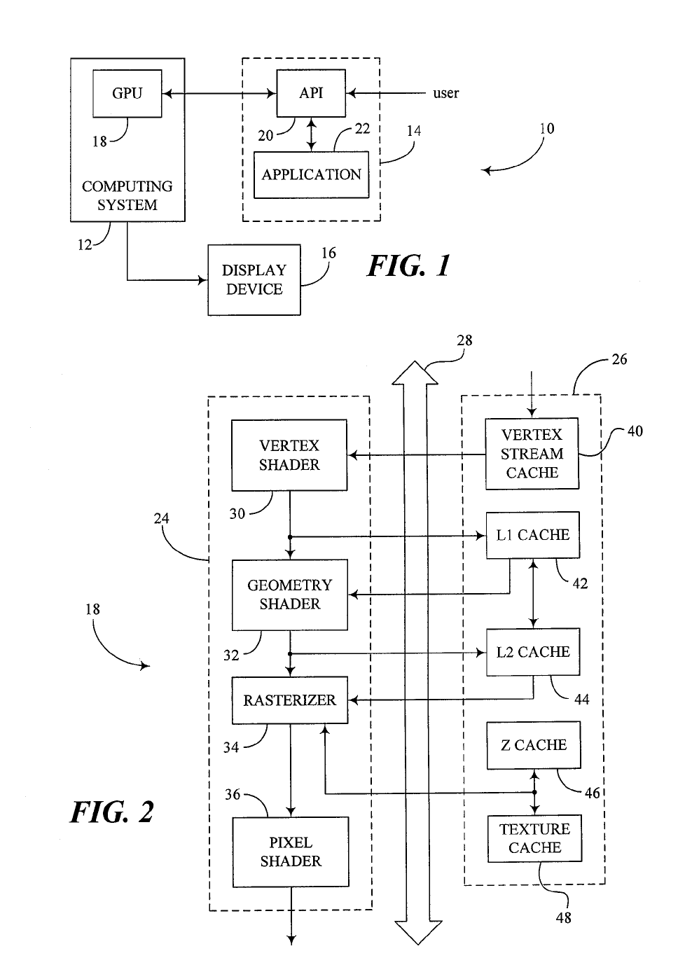

FIG. 2 is a block diagram of an embodiment of the GPU 18 shown in FIG. 1. In this embodiment, the GPU 18 includes a graphics processing pipeline 24 separated from a cache system 26 by a bus interface 28. The pipeline 24 includes a vertex shader 30, a geometry shader 32, a rasterizer 34, and a pixel shader 36. An output of the pipeline 24 may be sent to a write back unit (not shown). The cache system 26 includes a vertex stream cache 40, a level one (L1) cache 42, a level two (L2) cache 44, a Z cache 46, and a texture cache 48.

The vertex stream cache 40 receives commands and graphics data and transfers the commands and data to the vertex shader 30, which performs vertex shading operations on the data. The vertex shader 30 uses vertex information to create triangles and polygons of objects to be displayed. From the vertex shader 30, the vertex data is transmitted to geometry shader 32 and to the L1 cache 42. If necessary, some data can be shared between the L1 cache 42 and the L2 cache 44. The L1 cache can also send data to the geometry shader 32. The geometry shader 32 performs certain functions such as tessellation, shadow calculations, creating point sprites, etc. The geometry shader 32 can also provide a smoothing operation by creating a triangle from a single vertex or creating multiple triangles from a single triangle.

After this stage, the pipeline 24 includes a rasterizer 34, operating on data from the geometry shader 32 and L2 cache 44. Also, the rasterizer 34 may utilize the Z cache 46 for depth analysis and the texture cache 48 for processing based on color characteristics. The rasterizer 34 may include fixed function operations such as triangle setup, span tile operations, a depth test (Z test), pre-packing, pixel interpolation, packing, etc. The rasterizer 34 may also include a transformation matrix for converting the vertices of an object in the world space to the coordinates on the screen space.

After rasterization, the rasterizer 34 sends the data to the pixel shader 36 for determining the final pixel values. The pixel shader 36 includes processing each individual pixel and altering the color values based on various color characteristics. For example, the pixel shader 36 may include functionality to determine reflection or specular color values and transparency values based on position of light sources and the normals of the vertices. The completed video frame is then output from the pipeline 24. As is evident from this drawing, the shader units and fixed function units utilize the cache system 26 at a number of stages. Communication between the pipeline 24 and cache system 26 may include further buffering if the bus interface 28 is an asynchronous interface.

In this embodiment, the components of the pipeline 24 are configured as separate units accessing the different cache components when needed. However, in other embodiments described herein, the pipeline 24 can be configured in a simpler fashion while providing the same functionality. In this way, the shader components can be pooled together into a unified shader. The data flow can be mapped onto a physical device, referred to herein as an execution unit, for executing a range of shader functions. In this respect, the pipeline is consolidation into at least one execution unit capable of performing the functions of the pipeline 24. Also, some cache units of the cache system 26 may be incorporated in the execution units. By combining these components into a single unit, the graphics processing flow can be simplified and can include switching across the asynchronous interface. As a result, the processing can be kept local, thereby allowing for quicker execution.

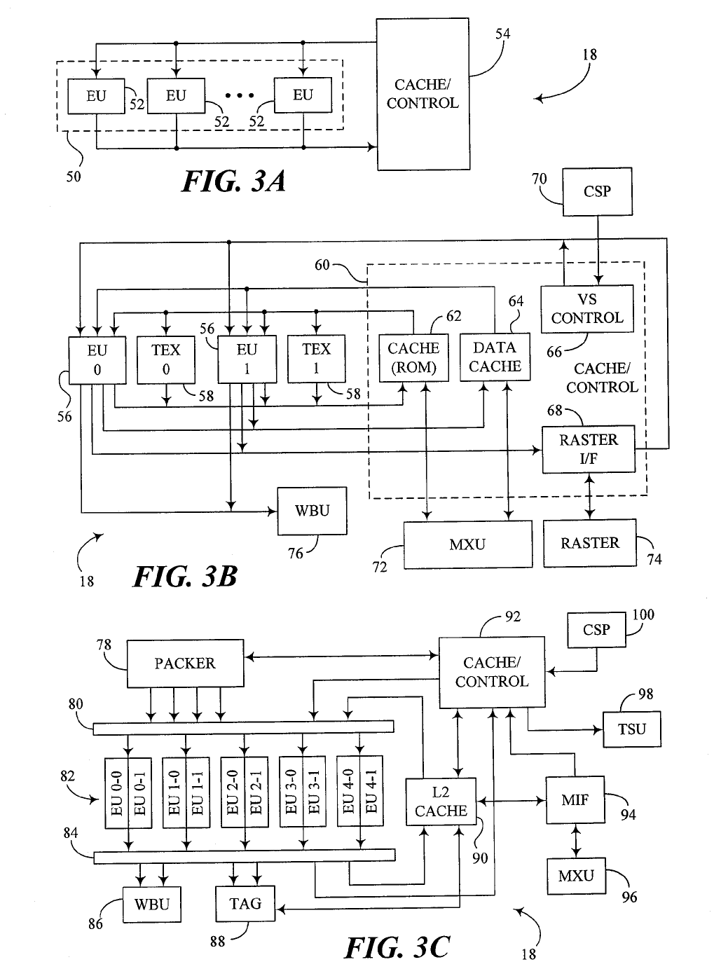

FIG. 3A is a block diagram of an embodiment of the GPU 18 shown in FIG. 1 or other graphics processing device. The GPU 18 includes a unified shader unit 50, which has multiple execution units (EUs) 52, and a cache/control device 54. The EUs 52 are oriented in parallel and accessed via the cache/control device 54. The unified shader unit 50 may include any number of EUs 52 to adequately perform a desired amount of graphics processing depending on various specifications. When more graphics processing is needed in a design, more EUs can be added. In this respect, the unified shader unit 50 can be defined as being scalable.

In this embodiment, the unified shader unit 50 has a simplified design having more flexibility than the conventional graphics processing pipeline. In other embodiments, each shader unit needed a greater amount of resources, e.g. caches and control devices, for operation. In this embodiment, the resources can be shared. Also, each EU 52 can be manufactured similarly and can be accessed depending on its current workload. Based on the workload, each EU 52 can be allocated as needed to perform one or more functions of the graphics processing pipeline 24. As a result, the unified shader unit 50 provides a more cost-effective solution for graphics processing.

Furthermore, when the design and specifications of the API 20 changes, which is common, the unified shader unit 50 is designed such that it does not require a complete re-design to conform to the API changes. Instead, the unified shader unit 50 can dynamically adjust in order to provide the particular shading functions according to need. The cache/control device 54 includes a dynamic scheduling device to balance the processing load according to the objects or scenes being processed. More EUs 52 can be allocated to provide greater processing power to specific graphics processing, such as shader functions or fixed functions, as determined by the scheduler. In this way, the latency can be reduced. Also, the EUs 52 can operate on the same instruction set for all shader functions, thereby simplifying the processing.

FIG. 3B is a block diagram of another embodiment of the GPU 18. Pairs of EU devices 56 and texture units 58 are included in parallel and connected to a cache/control device 60. In this embodiment, the texture units 58 are part of the pool of execution units. The EU devices 56 and texture units 58 can therefore share the cache in the cache/control device 60, allowing the texture unit 58 access to instructions/textures quicker than conventional texture units. The cache/control device 60 in this embodiment include a read-only cache 62 for instructions and textures, a data cache 64, a vertex shader control device (VS control) 66, and a raster interface 68. The GPU 18 also includes a command stream processor (CSP) 70, a memory access unit (MXU) 72, a raster 74, and a write back unit (WBU) 76.

Since the data cache 64 is a read/write cache and is more expensive than the read-only cache 62, these caches are kept separate. The read-only cache 62 may include about 32 cachelines, but the number may be reduced and the size of each cacheline may be increased in order to reduce the number comparisons needed. The hit/miss test for the read-only cache 62 may be different than a hit/miss test of a regular CPU, since graphics data is streamed continually. For a miss, the cache simply updates and keeps going without storing in external memory. For a hit, the read is slightly delayed to receive the data from cache. The read-only cache 62 and data cache 64 may be level one (L1) cache devices to reduce the delay, which is an improvement over conventional GPU cache systems that use L2 cache.

The VS control 66 receives commands and data from the CSP 70. The EUs 56 and TEXs 58 receive a stream of texture information, instructions, and constants from the cache 62. The EUs 56 and TEXs 58 also receive data from the data cache 64 and, after processing, provide the processed data back to the data cache 64. The cache 62 and data cache 64 communicate with the MXU 72. The raster interface 68 and VS control 66 provide signals to the EUs 56 and receive processed signals back from the EUs 56. The raster interface 68 communicates with a raster device 74. The output of the EUs 56 is also communicated to the WBU 76.

FIG. 3C is a block diagram of another embodiment of the GPU 18. In this embodiment, the GPU 18 includes a packer 78, an input crossbar 80, a plurality of pairs of EU devices 82, an output crossbar 84, a write back unit (WBU) 86, a texture address generator (TAG) 88, a level 2 (L2) cache 90, a cache/control device 92, a memory interface (MIF) 94, a memory access unit (MXU) 96, a triangle setup unit (TSU) 98, and a command stream processor (CSP) 100.

The CSP 100 provides a stream of indices to the cache/control device 92, where the indices pertain to an identification of a vertex. For example, the cache/control 92 may be configured to identify 256 indices at once in a FIFO. The packer 78, which is preferably a fixed function unit, sends a request to the cache/control device 92 requesting information to perform pixel shading functionality. The cache/control device 92 returns pixel shader information along with an assignment of the particular EU number and thread number. The EU number pertains to one of the multiple EU devices 82 and the thread number pertains to one of a number of parallel threads in each EU for processing data. The packer 78 then transmits texel and color information, related to pixel shading operations, to the input crossbar 80. For example, two inputs to the input crossbar 80 may be designated for texel information and two inputs may be designated for color information. Also, each input may be capable of transmitting 512 bits, for example.

The input crossbar 80, which can be a bus interface, routes the pixel shader data to the particular EU and thread according to the assignment allocation defined by the cache/control device 92. The assignment allocation may be based on the availability of EUs and threads, or other factors, and can be changed as needed. With several EUs 82 connected in parallel, a greater amount of the graphics processing can be performed simultaneously. Also, with the easy accessibility of the cache, the data traffic remains local without requiring fetching from a less-accessible cache. In addition, the traffic through the input crossbar 80 and output crossbar 84 can be reduced with respect to conventional graphics systems, thereby reducing processing time.

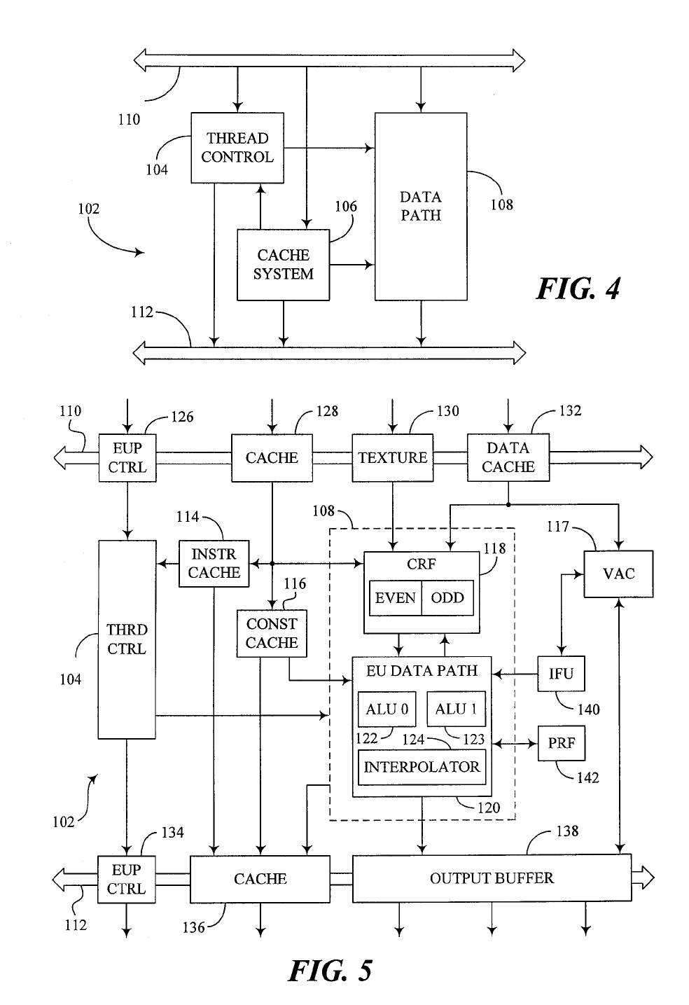

Each EU 82 processes the data using vertex shading and geometry shading functions according to the manner in which it is assigned. The EUs 82 can be assigned, in addition, to process data to perform pixel shading functions based on the texel and color information from the packer 78. As illustrated in this embodiment, five EUs 82 are included and each EU 82 is divided into two divisions, each division representing a number of threads. Each division can be represented as illustrated in the embodiments of FIGS. 4-6, for example. The output of the EU devices 82 is transmitted to the output crossbar 84.

When graphics signals are completed, the signals are transmitted from the output crossbar 84 to the WBU 86, which leads to a frame buffer for displaying the frame on the display device 16. The WBU 86 receives completed frames after one or more EU devices 82 process the data using pixel shading functions, which is the last stage of graphics processing. Before completion of each frame, however, the processing flow may loop through the cache/control 92 one or more times. During intermediate processing, the TAG 88 receives texture coordinates from the output crossbar 84 to determine addresses to be sampled. The TAG 88 may operate in a pre-fetch mode or a dependency read mode. A texture number load request is sent from the TAG 88 to the L2 cache 90 and load data can be returned to the TAG 88.

Also output from the output crossbar 84 is vertex data, which is directed to the cache/control device 92. In response, the cache/control device 92 may send data input related to vertex shader or geometry shader operations to the input crossbar 80. Also, read requests are sent from the output crossbar 84 to the L2 cache 90. In response, the L2 cache 90 may send data to the input crossbar 80 as well. The L2 cache 90 performs a hit/miss test to determine whether data is stored in the cache. If not in cache, the MIF 94 can access memory through the MXU 96 to retrieve the needed data. The L2 cache 90 updates its memory with the retrieved data and drops old data as needed. The cache/control device 92 also includes an output for transmitting vertex shader and geometry shader data to the TSU 98 for triangle setup processing.

FIG. 4 is a block diagram of an embodiment of a general execution unit (EU) 102. The EU 102 may be embodied as the EU 52 shown in FIG. 3A, the EU 56 shown in FIG. 3B, a half of the EU device 82 shown in FIG. 3C, or other suitable execution unit capable of parallel processing of multiple shader and fixed function operations. In this embodiment, the EU 102 includes a thread control device 104, a cache system 106, and a data path 108. These elements are communicated with other parts of the GPU 18 via input crossbar 110 and output crossbar 112. The input crossbar 110 and output crossbar 112 may correspond, for example, with the input crossbar 80 and output crossbar 84, respectively, shown in FIG. 3C.

The thread control device 104 includes control hardware to determine an appropriate allocation of the EU data path resources, i.e. data path 108 for shader code execution. An advantage of the compact processing pipeline defined by the data path 108 is to reduce the data flow, which may require fewer clock cycles and fewer cache misses. Also, the reduced data flow puts less pressure on the asynchronous interfaces, thus potentially reducing a bottleneck situation at these components. A reduction in processing time with respect to convention graphics processors may result with use of the EU 102.

The data path 108 is the core of the graphics processing pipeline and can be programmable. Because of the flexibility of the data path 108, a user can program the EU to perform a greater number of graphics operations than conventional real-time graphics processors. The data path 108 includes hardware functionality to support vertex shading processing, geometry shading processing, triangle setup, interpolation, pixel shading processing, etc. Because of the compactness of the EU 102, the need to send data out to memory and later retrieve the data is reduced. For example, if the data path 108 is processing a triangle strip, several vertices of the triangle strip can be handled by one EU while another EU simultaneously handles several other vertices. Also, for triangle rejection, the data path 108 can more quickly determine whether or not a triangle is rejected, thereby reducing delay and unnecessary computations.

In some embodiments, the input crossbar 110 and output crossbar 112 are asynchronous interfaces allowing the EU to operate at a clock speed different from the remaining portions of the GPU. For example, the EU may operate at a clock speed that is twice the speed of the GPU clock. Also, the data path 108 may further operate at a clock speed that is twice the speed of the thread control 104 and cache system 106. Because of the difference in clock speeds, the crossbars 110 and 112 may be configured with buffers to synchronize processing between the internal EU components and the external components. These or other similar buffers are shown, for example, in FIG. 5.

FIG. 5 is a block diagram of an embodiment of the EU 102 of FIG. 4 illustrated in greater detail. In this embodiment, the cache system 106 as illustrated includes an instruction cache 114, a constant cache 116, and a vertex and attribute cache 117. The data path 108 as illustrated includes a common register file (CRF) 118 and an EU data path 120. The CRF 118 includes even and odd paths. The EU data path 120 includes arithmetic logic units (ALUs) 122, 123 and an interpolator 124. The input crossbar 110 includes an execution unit pool control (EUP control) 126, cache 128, texture buffer 130, and data cache 132. The output crossbar 112 includes an EUP control 134, cache 136, and an output buffer 138. The embodiment of FIG. 5 also includes an indexing input fetch unit (IFU) 140 and a predicate register file (PRF) 142.

Because of the asynchronous nature of the input crossbar 110 and output crossbar 112, the asynchronous interfaces include buffers to coordinate processing with external components of the GPU. Signals from the EUP control 126 are transmitted to the thread control 104 to maintain multiple threads of the data path 108. The cache 128 sends instructions and constants to the instruction cache 114 and constant cache 116, respectively. Texture coordinates are transmitted from the texture buffer 130 to the CRF 118. Data is transmitted from the data cache 132 to the CRF 118 and VAC 117.

The instruction cache 114 sends an instruction fetch to the thread control 104. In this embodiment, a large portion of the fetches will be hits, and a small portion of fetches that are misses are sent from the instruction cache 114 to the cache 136 for retrieval from memory. Also, the constant cache 116 sends misses to the cache 136 for retrieval. The processing of the data path 108 includes loading the CRF 118 with data according to an even or odd designation. Data on the even side is transmitted to ALU 0 (122) and data on the odd side is transmitted to ALU 1 (123). The ALUs 122, 123 may include shader processing hardware to process the data as needed, depending on the assignment from the thread control device 104. Also in the EU data path 120, the data is sent to interpolator 124.

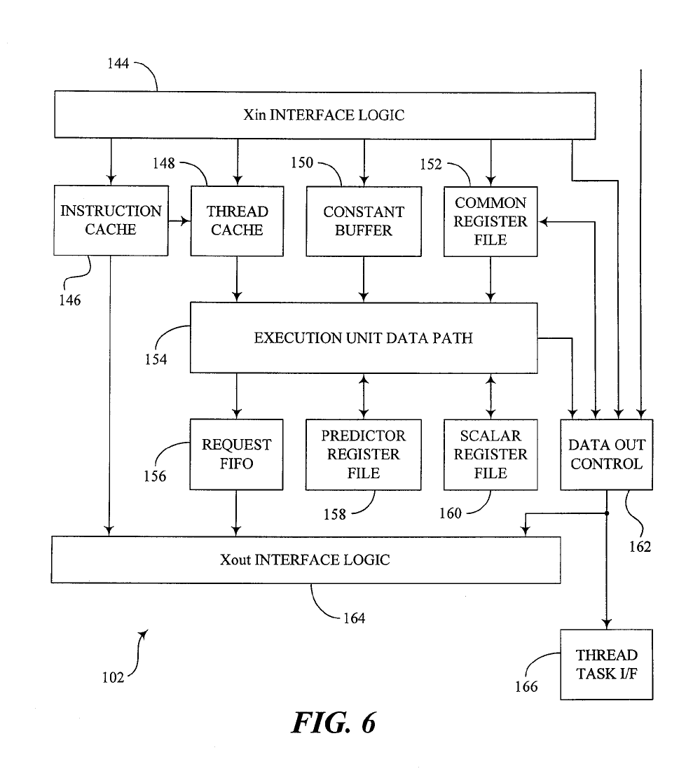

FIG. 6 is a block diagram of another embodiment of the EU 102 of FIG. 4 showing greater detail. In this embodiment, the EU 102 may include one-half of an EU device 82 as depicted in FIG. 3C. The EU half 102 (EU 0 or EU 1) includes Xin interface logic, also known as input bus interface, 144, an instruction cache 146, a thread cache 148, a constant buffer 150, and a common register file 152. The EU half 102 further includes an execution unit data path 154, a request FIFO 156, a predicate register file 158, a scalar register file 160, a data out control 162, Xout interface logic, also known as output bus interface, 164, and a thread task interface 166.

The instruction cache 146 can be an L1 cache and may include, for example, about 8 Kbytes of static random access memory (SRAM). The instruction cache 146 receives instructions from the Xin interface logic 144. Instruction misses are sent as requests to the Xout interface logic 164. The thread cache 148 receives assignment threads and issues instructions to the execution unit data path 154. In some embodiments, the thread cache 148 includes 32 threads. The constant buffer 150 receives constants from the Xin interface logic 144 and loads the constant data into the execution unit data path 154. The constant buffer in some embodiments includes 4 Kbytes of memory. The CRF 152 receives texel data, which is transmitted to the execution unit data path 154. The CRF 152 may include 16 Kbytes of memory, for example.

The execution unit data path 154 decodes the instructions, fetches operands, and performs branch computations. The execution unit data path 154 further performs floating point or integer calculation of the data and shift/logic, deal/shuffle, and load/store operations. Texel data and misses are transmitted from the execution unit data path 154 via the request FIFO 156 to the Xout interface logic 164. The PRF 158 and SRF 160 may be 1 Kbyte each, for example, and provide data to the execution unit data path 154 as needed.

Control signals are input from outside the EU 102 to the data out control device 162. The data out control 162 also receives signals from the execution unit data path 154 and data from the Xin interface logic 144. The data out control 162 may also request data from the CRF 152 as needed. The data out control device 162 outputs data to the Xout interface logic 164 and to the thread task interface for determining the future task assignment of threads according to the completed or in-progress data.

The data flow through the execution unit data path 154 may be classified into three levels, including a context level, a thread level and an instruction (execution) level. At any given time, there are two contexts in each EU. The context information is passed to the execution unit data path 154 before a task of this context is started. Context level information, for example, includes shader type, number of input/output registers, instruction starting address, output mapping table, horizontal swizzle table, vertex identification, and constants in the constant buffer 150.

In the thread level, where each EU can contain up to 32 threads, for example, in the thread cache 148. Threads correspond to functions similar to a vertex shader, geometry shader, or pixel shader. One bit is used to distinguish between the two contexts to be used in the thread. The threads are assigned to one of the thread slots in the execution unit data path that is not completely full. The thread slot can be empty or partially used. The threads are divided into even and odd groups, each containing a queue of 16 threads, for example. After the thread has started, the thread will be put into an eight-thread buffer, for example. The thread fetches instructions according to a program counter to fetch up to 256 bits, for example, of instruction data in each cycle. The thread will stay inactive if waiting for some incoming data. Otherwise, the thread will be in an active mode.

The arbitration of thread execution pairs two active threads together from the eight-thread buffer, depending on the age of the threads and other resource conflicts, such as ALU or CRF conflicts. Since some of the thread may enter inactive mode during execution, better pairing of the eight threads can be achieved. At the end of execution, the thread is moved from the working buffer and an end-of-program token is issued down stream. The token enters the data out control device 162 to move the data out to the Xout interface logic 164. Once all data is moved out, the thread will be removed from the thread slot and the execution unit data path 154 is notified. The data out control 162 also moves data from the CRF 152 according to a mapping table. Once the registers are clear, the execution unit data path 154 can load the CRF 152 for the next thread.

Regarding the instruction data flow, the thread execution generates an instruction fetch. For example, there may be 64 bits of data in each compressed instruction. The thread control can decompress the instruction, if necessary, and perform a scoreboard test and then proceed to an arbitration stage. In order to increase efficiency, the hardware can pair the instructions from different threads.

The instruction fetch scheme between thread control and instruction cache may include a miss, which returns a four-bit set address plus a two-bit way address. A broadcast signal of the incoming data from the Xin interface logic 144 may be received. The instruction fetch may also include a hit, in which the data is received on the next clock cycle. A hit-on-miss may be similar to a miss result. Miss-on-miss may return a four-bit set address and the broadcast signal from the Xin interface logic can be received on a second request. In order to keep the thread running, the scoreboard maintains requested data that comes back. A thread can be stalled if the incoming instruction needs this data to proceed.

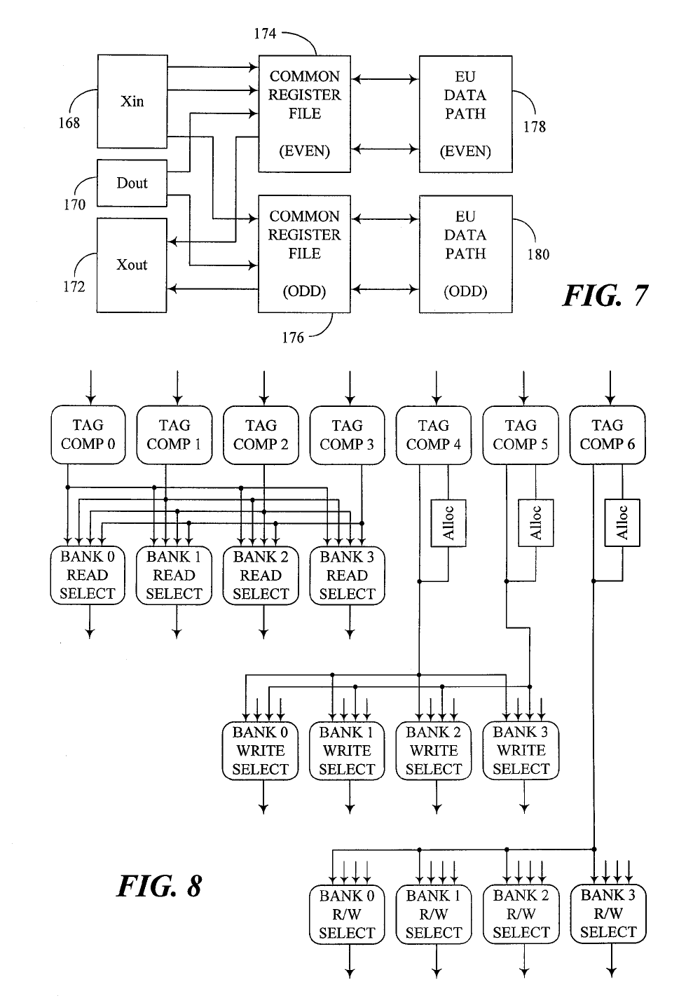

FIG. 7 illustrates a block diagram of an embodiment of common register file interfaces of the EU 102 of FIG. 4, 5, or 6. FIG. 8 illustrates corresponding signal transmission for the CRF interfaces. In FIG. 7, the CRF interface embodiment includes Xin logic 168, data out control (Dout) 170, Xout logic 172, CRF (even) 174, CRF (odd) 176, EU data path (even) 178, and EU data path (odd) 180. In FIG. 8, read and write data, in accordance with assigned threads, is received as tag comparisons. Outputs therefrom are directed to bank read selects and then to bank read ports. Outputs of tag comparisons 4-6 are described in this example as misses, which are sent to an allocation device. From the tag comparison 4 and 5 allocations, the signals are sent to bank write selects and then to bank write ports. From tag comparison 6, the signals are sent to bank R/W selects and then to bank R/W ports.

The unified shaders and execution units of the present disclosure can be implemented in hardware, software, firmware, or a combination thereof. In the disclosed embodiments, portions of the unified shades and execution units implemented in software or firmware, for example, can be stored in a memory and can be executed by a suitable instruction execution system. Portions of the unified shaders and execution units implemented in hardware, for example, can be implemented with any or a combination discrete logic circuitry having logic gates, an application specific integrated circuit (ASIC), a programmable gate array (PGA), a field programmable gate array (FPGA), etc.

The functionality of the unified shaders and execution units described herein can include an ordered listing of executable instructions for implementing logical functions. The executable instructions can be embodied in any computer-readable medium for use by an instruction execution system, apparatus, or device, such as a computer-based system, processor-controlled system, or other system. A “computer-readable medium” can be any medium that can contain, store, communicate, propagate, or transport the program for use by the instruction execution system, apparatus, or device. The computer-readable medium can be, for example, an electronic, magnetic, optical, electromagnetic, infrared, or semiconductor system, apparatus, device, or propagation medium.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

I claim:

1. A graphics processing unit (GPU) comprising:
a control device configured to receive vertex data; and
a unified shader unit having a plurality of execution units connected in parallel, each execution unit configured to perform at least one of a plurality of graphics shading functions on the vertex, geometry and pixel data;
wherein the control device is further configured to allocate a portion of the vertex, geometry and pixel data to each execution unit; and
wherein the control device allocates the vertex, geometry and pixel data in a manner to substantially balance the load among the execution units.

2. The GPU of claim 1, wherein the plurality of graphics shading functions includes vertex shading functionality, geometry shading functionality, and pixel shading functionality.

3. The GPU of claim 1, wherein the plurality of graphics shading functions further includes rasterization functionality.

4. The GPU of claim 3, wherein the rasterization functionality includes at least one function selected from a triangle setup function, a span-tile generation function, a Z-test function, and a pixel color interpolation function.

5. The GPU of claim 1, wherein the unified shader unit further comprises a plurality of texture units in parallel with the execution units.

6. The GPU of claim 5, wherein the control device includes read-only cache and data cache, the execution units and texture units configured to share the read-only cache and data cache.

7. The GPU of claim 1, further comprising an asynchronous input crossbar and an asynchronous output crossbar, wherein the execution units are connected in parallel between the input crossbar and output crossbar, and wherein the control device controls the allocation of vertex data to the execution units via the input crossbar.

8. The GPU of claim 7, wherein the control device further comprises a packer in communication with the input crossbar.

9. The GPU of claim 7, wherein the control device further comprises a write back unit and texture address generator in communication with the output crossbar.

10. The GPU of claim 1, further comprising a command stream processor configured to feed a stream of input vertex data to the control device.

11. An execution unit comprising:
a data path having logic for performing vertex shading functionality, logic for performing geometry shading functionality, and logic for performing pixel shading functionality;
a cache system; and
a thread control device configured to control the data path based on an allocation assignment;
wherein the data path is further configured to perform one or more of the vertex shading functionality, geometry shading functionality, or pixel shading functionality based on the allocation assignment.

12. The execution unit of claim 11, wherein the data path further comprises logic for performing rasterization functionality.

13. The execution unit of claim 11, wherein the data path further comprises a common register file and an execution unit data path.

14. The execution unit of claim 13, wherein the common register file comprises a first channel designated for even threads and a second channel designated for odd threads.

15. The execution unit of claim 13, wherein the execution unit data path includes arithmetic logic units and an interpolator.

16. The execution unit of claim 11, wherein the cache system comprises an instruction cache, a constant cache, and a vertex and attribute cache.

17. The execution unit of claim 11, wherein the data path is connected between an asynchronous input bus interface and an asynchronous output bus interface to decouple data path clock frequency domain from other parts of GPU.

18. The execution unit of claim 11, wherein the data path is configured to operate at a clock speed at least two times the speed of an external clock.

19. The execution unit of claim 17, further comprising a data out control device configured to control input and output logic associated with the input bus interface and output bus interface.

20. The execution unit of claim 11, further comprising a predicate register file and a scalar register file.
